(19) United States
(12) Patent Application Publication
(10) Pub. No.: US 2009/0170985 A1
(43) Pub. Date: Jul. 2, 2009

(54) POLYESTER-POLYAMIDE COMPOSITIONS, ARTICLES, AND METHOD OF MANUFACTURE THEREOF

(76) Inventors: Rina Ai, Shanghai (CN); Gerben Bernardus Wilhelmus Hieltjes, Breda (NL); Chris van der Weele, Sommelsdijk (NL)

Correspondence Address: CANTOR COLBURN, LLP, 20 Church Street, 22nd Floor, Hartford, CT, 06103, US

(21) Appl. No.: 11/966,039

(22) Filed: Dec. 28, 2007

(51) Int. Cl. C08K 5/3492

(52) U.S. Cl. 524/100

(57) ABSTRACT

A composition is disclosed, comprising, based on the total weight of the composition: from 5 to 60 wt. % of a poly(ethylene terephthalate) having an intrinsic viscosity from 0.5 to 0.9 dl/g; from 0.5 to 10 wt. % of a melamine component; from 5 to 20 wt. % of a halogenated organic flame retarding synergist; from more than 0 to 25 wt % of a polyamide, from 2 to 10 wt. % of an inorganic flame retarding synergist; from 0.1 to 5 wt. % of an anti-dripping agent; and from 10 to 50 wt. % of a reinforcing filler; The invention also relates to articles made from the composition, methods for making the composition, and methods for using the composition.

### BACKGROUND OF THE INVENTION

Polyesters and polyester copolymers are well known thermoplastic polymers, and are useful for the manufacture of a wide variety of articles, from fibers to packaging to electronic components. Manufacturers of electrical components such as relay housing controls, timer housing structures, connectors, controls and switches have an ongoing need for materials that exhibit properties that are suitable for the components' intended operating conditions. Such materials must also meet stringent flame retardancy requirements.

Glass and/or mineral-filled flame retardant polyesters are especially useful in electronic components because of their good dimensional stability and electrical and flame retardant properties. However, new regulations require that materials used in unattended appliances with a current of greater than 0.2 A must comply with a glow wire flammability test of 850° C. and shall have no ignition at 750° C. Such materials often are also required to have a comparative tracking index (CTI) requirement of Class 2 (greater than 250V) or higher. These standards are difficult to meet using current polyester materials, particularly in view the need to meet the CTI Class 2 or higher requirement. While some compositions, particularly those based on poly(butylene terephthalate) (PBT), can meet the CTI class 2, these same compositions will fail the glow wire ignition test. Conversely, other compositions based on poly(ethylene terephthalate) (PET) will meet the glow wire ignition test, but not CTI Class 2.

There accordingly remains a need in the art for polyester materials useful for making electrical components that are highly flame retardant.

### SUMMARY

A composition comprising, based on the total weight of the composition:

from 5 to 60 wt. % of a poly(ethylene terephthalate) having an intrinsic viscosity from 0.5 to 0.9 dl/g;

from 5 to 20 wt. % of a polyamide;

from 0.5 to 10 wt. % of a melamine component

from 5 to 20 wt. % of a halogenated organic flame retarding synergist;

from 2 to 10 wt. % of an inorganic flame retarding synergist;

from 0.1 to 5 wt. % of an anti-dripping agent; and

from 10 to 50 wt. % of a reinforcing filler;

In a specific embodiment, a 3-millimeter thick sample comprising the foregoing composition has a Glow Wire Ignition Temperature of at least 775° C.; and wherein a sample comprising the composition has a Comparative Tracking Index of at least 250 Volts.

A composition comprising, based on the total weight of the composition:

from 5 to 60 wt. % of a poly(ethylene terephthalate) having an intrinsic viscosity from 0.5 to 0.9 dl/g;

from 5 to 20 wt. % of a polyamide;

from 2.5 to 7.5 wt. % of melamine polyphosphate;

from 10 to 15 wt. % of a halogenated organic flame retarding synergist;

from 2.5 to 7.5 wt. % of an inorganic flame retarding synergist;

from 0.1 to 0.8 wt. % of an anti-dripping agent; and

from 25 to 35 wt. % of a reinforcing filler;

wherein a 3 millimeter thick sample comprising the composition has a Glow Wire Ignition Temperature of at least 775° C.;

a 0.8 millimeter thick sample comprising the composition meets the UL 94 standard of V0; and

wherein a sample comprising the composition has a Comparative Tracking Index of at least 250 Volts.

A composition comprising, based on the total weight of the composition:

from 10 to 50 wt. % of a poly(ethylene terephthalate) having an intrinsic viscosity from 0.5 to 0.9 dl/g;

from 5 to 20 wt. % of a polyamide;

from 2.5 to 7.5 wt. % of melamine polyphosphate;

from 10 to 15 wt. % of a halogenated organic flame retarding synergist;

from 2.5 to 7.5 wt. % of an inorganic flame retarding synergist;

from 0.1 to 0.8 wt. % of an anti-dripping agent; and

from 10 to 50 wt. % of a reinforcing filler;

wherein a 1 millimeter thick sample comprising the composition has a Glow Wire Ignition Temperature of at least 775° C.;

wherein a 0.8 millimeter thick sample comprising the composition meets the UL 94 standard of V0; and

wherein a sample comprising the composition has a Comparative Tracking Index of at least 400 Volts.

In another embodiment, an article comprises one of the above-described compositions.

In yet another embodiment, a method of forming a composition comprises melt blending the above-described components.

In still another embodiment, a method of forming an article comprises shaping, extruding, blow molding, or injection molding one of the above-described compositions to form the article.

These and other features, aspects, and advantages of the present invention will become better understood with reference to the following description and appended claims.

### DESCRIPTION OF THE INVENTION

The invention is based on the discovery that by using specific combinations comprising a poly(ethylene terephthalate) having an intrinsic viscosity from 0.5 to 0.9 dl/g, melamine polyphosphate or melamine cyanurate, a halogenated organic flame retarding synergist, a polyamide, an inorganic flame retarding synergist, an anti-dripping agent, and a reinforcing filler, it is possible to obtain a composition having a desired combination of physical properties. The compositions are useful in making molded products such as electrical components. Advantageously, the composition and articles made from the composition exhibit excellent performance properties. In particular, these materials can both meet the glow wire ignition test at 750° C., and achieve a CTI Class 2 rating. In particular, a 3-millimeter thick sample comprising the composition has a Glow Wire Ignition Temperature of at least 775° C.; a 1-millimeter thick sample comprising the composition has a Glow Wire Ignition Temperature of at least 775° C.; and a sample comprising the composition has a Comparative Tracking Index of at least 250 Volts. The compositions form articles that are also dimensionally stable.

The singular forms “a,” “an,” and “the” include plural referents unless the context clearly dictates otherwise. The terms “first,” “second,” and the like herein do not denote any order, quantity, or importance, but rather are used to distinguish one element from another. Unless defined otherwise, technical and scientific terms used herein have the same meaning as is commonly understood by one of skill. Compounds are described using standard nomenclature.

Other than in the operating examples or where otherwise indicated, all numbers or expressions referring to quantities of ingredients, reaction conditions, and the like, used in the specification and claims are to be understood as modified in all instances by the term “about.” Various numerical ranges are disclosed in this patent application. Because these ranges are continuous, they include every value between the minimum and maximum values. Unless expressly indicated otherwise, the various numerical ranges specified in this application are approximations. The endpoints of all ranges directed to the same component or property are inclusive of the endpoint and independently combinable.

Glow Wire Ignition Temperature (GWIT), measured in accordance with IEC 60695-2-13, is expressed as the temperature (in degrees C.), which is 25° C. hotter than the maximum temperature of the tip of the glow-wire that does not cause ignition of the material during three subsequent tests.

Comparative Tracking Index (CTI) is expressed as that voltage which causes tracking after 50 drops of 0.1 percent ammonium chloride solution have fallen on the material. The results of testing at the nominal 3 mm thickness are considered representative of the material's performance in any thickness.

The V0 rating is a well-known and accepted flammability performance standard for plastic materials, as well as UL 94 ratings. This standard is intended to provide an indication of a material's ability to extinguish a flame, once ignited. Several ratings can be applied based on the rate of burning, time to extinguish, ability to resist dripping, and whether or not drips are burning. Each material tested may receive several ratings based on color and/or thickness. When specifying a material for an application, the UL rating should be applicable for the thickness used in the wall section in the plastic part. The UL rating should always be reported with the thickness; just reporting the UL rating without mentioning thickness is insufficient. V-0 burning stops within 10 seconds on a vertical specimen; no burning drips and no burn to holding clamp allowed. Compositions of this invention can be expected to achieve a UL94 rating of V0 at a thickness that is suitably lower than 1.5 mm and typically at 0.8 mm.

It has been found that use of poly(ethylene terephthalate) having an intrinsic viscosity from 0.5 to 0.9 dl/g is critical to providing the desired flame retardancy to the composition. The poly(ethylene terephthalate) can more specifically have an intrinsic viscosity from 0.55 or 0.6 to 0.8 dl/g. The poly(ethylene terephthalate) is present in the compositions in an amount from 5 to 60 wt. %, more specifically 5 to 50 wt. %, and even more specifically 20 to 35 wt. %, based on the total weight of the composition.

In one embodiment, the composition can comprise a polyester that is different from the poly(ethylene terephthalate). As such, other polyesters can be present in the composition, provided that such polyesters do not significantly adversely affect the desired properties of the composition, in particular the flame retardant properties. Specific exemplary poly(alkylene terephthalate)polyesters include, poly(butylene terephthalate) (PBT), poly(ethylene naphthalate) (PEN), poly(butylene naphthalate) (PBN), and poly(1,3-propylene terephthalate) (PPT). Another class of polyesters includes at least one cycloaliphatic moiety, for example poly(1,4-cyclohexylendimethylene terephthalate) (PCT), poly(1,4-cyclohexylenedimethylene cyclohexane-1,4-dicarboxylate) also known as poly(cyclohexane-14-dimethanol cyclohexane-1,4-dicarboxylate) (PCCD), and poly(1,4-cyclohexylenedimethlylene terephthalate-co-isophthalate) (PCTA). Other useful polyesters are copolyesters derived from an aromatic dicarboxylic acid (specifically terephthalic acid and/or isophthalic acid) and a mixture comprising a linear C₂₋₆ aliphatic diol (specifically ethylene glycol and butylene glycol); and a C₆₋₁₂ cycloaliphatic diol (specifically 1,4-hexane diol, dimethanol decalin, dimethanol bicyclooctane, 1,4-cyclohexane dimethanol and its cis- and trans-isomers, 1,10-decane diol, and the like) or a linear poly(C₂₋₆ oxyalkylene)diol (specifically, poly(oxyethylene)glycol) and poly(oxytetramethylene)glycol). The poly(oxyalkylene)glycol can have a molecular weight of 200 to 10,000 grams per mole, more specifically 400 to 6,000 grams per mole, even more specifically 600 to 2,000 grams per mole, and a carbon to oxygen ratio of 1 to 10, more specifically 1.5 to 6, even more specifically 2.0 to 4.3. The ester units comprising the two or more types of diols can be present in the polymer chain as individual units or as blocks of the same type of units. Specific esters of this type include poly(1,4-cyclohexylene dimethylene co-ethylene terephthalate) (PCTG) wherein greater than 50 mol % of the ester groups are derived from 1,4-cyclohexanedimethanol; and poly(ethylene-co-1,4-cyclohexylenedimethylene terephthalate) wherein greater than 50 mol % of the ester groups are derived from ethylene (PTCG). Also included are thermoplastic poly(ester-ether) (TPEE) copolymers such as poly(ethylene-co-poly(oxytetramethylene)terephthalate. Also contemplated for use herein are any of the above polyesters with minor amounts, e.g., from 0.5 to 5 percent by weight, of units derived from aliphatic acid and/or aliphatic polyols to form copolyesters. In another embodiment, the composition does not further comprises a polyester that is different from the poly(ethylene terephthalate).

When used, the additional polyester is present in an amount of more than 0 to 25 wt. %, or more than 0 to 20 wt. %, based on the total weight of the composition.

A polyamide is also present in the composition. When used, the polyamide passes a more stringent flame retardancy standard. Combinations of different polyamides, as well as various polyamide copolymers, can be used.

Suitable polyamide resins are a generic family of resins known as Nylons, characterized by the presence of an amide group (—C(O)NH—). Nylon-6 and Nylon-6,6 are the generally used polyamides and are available from a variety of commercial sources. Other polyamides, however, such as Nylon-4,6, Nylon-12, Nylon-6,10, Nylon-6,9, Nylon-6/6T and Nylon-6,6/6T with triamine contents below 0.5 wt. %, as well as others, such as the amorphous nylons, may be useful for particular applications. A specific polyamide is Nylon-6, 6.

The polyamides can be obtained by a number of well-known processes such as those described in U.S. Pat. Nos. 2,071,250; 2,071,251; 2,130,523; 2,130,948; 2,241,322; 2,312,966; and 2,512,606. Nylon-6, for example, is a polymerization product of caprolactam. Nylon-6, 6 is a condensation product of adipic acid and 1,6-diaminohexane. Likewise, Nylon-4, 6 is a condensation product of adipic acid and 1,4-diaminobutane. Besides adipic acid, other useful diacids for the preparation of Nylons include azelaic acid, sebacic acid, dodecane diacid, as well as terephthalic and isophthalic acids, and the like. Other useful diamines include m-xylyene diamine, di-(4-aminophenyl)methane, di-(4-aminocyclohexyl)methane, 2,2-di-(4-aminophenyl)propane, 2,2-di-(4-aminocyclohexyl)propane, among others. Copolymers of caprolactam with diacids and diamines are also useful.

Specific examples of polyamides include those selected from polycaproamide, polyhexamethylene adipamide, polyhexathylene sebacamide, polyundecamethylene adipamide, polyundecanamide, polydodecanamide copolymerized polyamides of the foregoing, and combinations thereof.

The polyamide is present in the composition in an amount from more than 0 to 25 wt. %, or from 15 to 25 wt. %, even more specifically from 10 to 15 wt. %, based on the total weight of the composition.

In one embodiment, the composition contains polycarbonate in an amount from more than 0 to less than 22 wt. %, based on the total weight of the composition. As used herein, the term “polycarbonate” means compositions having repeating structural carbonate units of formula (1):

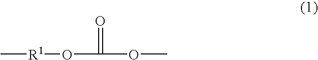

in which at least 60 percent of the total number of R¹ groups contain aromatic moieties and the balance thereof are aliphatic, alicyclic, or aromatic. In an embodiment, each R¹ is a C₆₋₃₀ aromatic group, that is, contains at least one aromatic moiety. R¹ can be derived from a dihydroxy compound of the formula (2)

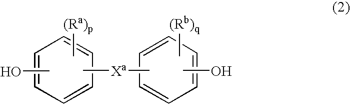

wherein R^{a} and R^{b} each represent a halogen or C₁₋₁₂ alkyl group and can be the same or different; and p and q are each independently integers of 0 to 4. It will be understood that R^{a} is hydrogen when p is 0, and likewise R^{b} is hydrogen when q is 0. Also in formula (3), X^{a} represents a bridging group connecting the two hydroxy-substituted aromatic groups, where the bridging group and the hydroxy substituent of each C₆ arylene group are disposed ortho, meta, or para (specifically para) to each other on the C₆ arylene group. In an embodiment, the bridging group X^{a} is single bond, —O—, —S—, —S(O)—, —S(O)₂—, —C(O)—, or a C₁₋₁₈ organic group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. In one embodiment, p and q is each 1, and R^{a} and R^{b} are each a C₁₋₃ alkyl group, specifically methyl, disposed meta to the hydroxy group on each arylene group. In another embodiment, X^{a} is a substituted or unsubstituted C₃₋₁₈ cycloalkylidene, a C₁₋₂₅ alkylidene of formula —C(R^{c})(R^{d})—wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl, or a group of the formula —C(═R^{e}) wherein R^{e} is a divalent C₁₋₁₂ hydrocarbon group. Exemplary groups of this type include methylene, cyclohexylmethylene, ethylidene, neopentylidene, and isopropylidene, as well as 2-[2.2.1]-bicycloheptylidene, cyclohexylidene, cyclopentylidene, cyclododecylidene, and adamantylidene. Other useful aromatic dihydroxy compounds of the formula HO—R¹—OH include compounds of formula (3)

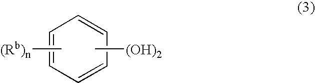

wherein each R^{h} is independently a halogen atom, a C₁₋₁₀ hydrocarbyl such as a C₁₋₁₀ alkyl group, a halogen-substituted C₁₋₁₀ alkyl group, a C₆₋₁₀ aryl group, or a halogen-substituted C₆₋₁₀ aryl group, and n is 0 to 4. The halogen is usually bromine.

Some illustrative examples of specific aromatic dihydroxy compounds include the following: 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis(hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantane, alpha, alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalimide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, resorcinol, substituted resorcinol compounds such as 5-methyl resorcinol, 5-ethyl_resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinonie, 2-ethyl hydroquinone, 2-propyl hydroquinone, 2-butyl hydroquinone, 2-t-butyl hydroquinone, 2-phenyl hydroquinone, 2-cumyl hydroquinonie, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like, or combinations comprising at least one of the foregoing dihydroxy compounds.

Specific examples of bisphenol compounds of formula (2) include 1,1-bis(4-hydroxyphenyl)methane, 1,1-bis(4-hydroxyphenyl)ethane, 2,2-bis(4-hydroxyphenyl)propane (hereinafter “bisphenol A” or “BPA” ), 2,2-bis(4-hydroxyphenyl)butane, 2,2-bis(4-hydroxyphenyl)octane, 1,1-bis(4-hydroxyphenyl)propane, 1,1-bis(4-hydroxyphenyl)n-butane, 2,2-bis(4-hydroxy-1-methylphenyl)propane, 1,1-bis(4-hydroxy-t-butylphenyl)propane, 3,3-bis(4-hydroxyphenyl)phthalimidine, 2-phenyl-3,3-bis(4-hydroxyphenyl)phthalimidine (PPPBP), and 1,1-bis(4-hydroxy-3-methylphenyl)cyclohexane (DMBPC). Combinations comprising at least one of the foregoing dihydroxy compounds can also be used. In one specific embodiment, the polycarbonate is a linear homopolymer derived from bisphenol A, in which each of A¹ and A² is p-phenylene and Y¹ is isopropylidene in formula (2).

The particular flame retardancy characteristics of the composition are attained by use of a specific combination of flame retardants.

The melamine component can be a melamine-based material, which when used with the other components of the composition, results in a composition having a useful combination of properties. Examples of suitable materials can include melamine cyanurate and the melamine phosphates, including melamine phosphate, melamine polyphosphate, and melamine pyrophosphate. In one embodiment the melamine component, such as melamine polyphosphate, melamine cyanurate, or a combination thereof is present in the composition in an amount from 0.5 to 10 wt. %, specifically 2 to 8 wt. %, more specifically 2.5 to 7.5 wt. %, based on the total weight of the composition. In a specific embodiment, melamine polyphosphate is used.

A halogenated organic flame retarding synergist is also present. A wide variety of different synergists can be used. Examples of suitable halogenated fire retarding agents include ethane-1,2-bis(pentabromophenlyl), brominated polystyrene, poly(pentabromobenzylacrylate), 1,2-bis-(tetrabromophthalimido)ethane, phenol-capped carbonate pentamers of tetrabromobisphenol A carbonate oligomers (TBBPA), 2,4,6-tribromophenol-capped tetrabromobisphenol A-carbonate oligomers, brominated polycarbonates, and tetrabromobisphenol A diglycidyl ether. Combinations of halogenated organic flame retarding synergists can be used. The halogenated organic flame retarding synergist components are made by known methods and are commercially available from various vendors.

The halogenated organic flame retarding synergist is present in the composition in an amount from 5 to 20 wt. %, specifically 5 to 15 wt. %, more specifically 5 to 10 wt. % or from 10 to 15 wt. %, based on the total weight of the composition.

The melamine pyrophosphate and the halogenated organic flame retarding synergist are used in conjunction with an inorganic flame retarding synergist, for example antimony containing compounds such as antimony trioxide (Sb₂O₃), antimony pentoxide (Sb₂O₅), sodium antimonate, and combinations thereof. Such synergists are present in the compositions in amounts from 2 to 10 wt. %, more specifically from 3 to 7 wt. %, or from 2.5 to 7.5 wt. %, based on the total weight of the composition.

An anti-dripping agent is also present in the composition. Anti-dripping agents include, for example a fibril-forming or non-fibril forming fluoropolymer such as polytetrafluoroethylene (PTFE). The anti-drip agent can be encapsulated by a rigid copolymer, for example styrene-acrylonitrile copolymer (SAN). PTFE encapsulated in SAN is known as TSAN. Encapsulated fluoropolymers can be made by polymerizing the encapsulating polymer in the presence of the fluoropolymer, for example an aqueous dispersion. An exemplary TSAN can comprise about 50 wt. % PTFE and about 50 wt. % SAN, based on the total weight of the encapsulated fluoropolymer. The SAN can comprise, for example, about 75 wt. % styrene and about 25 wt. % acrylonitrile based on the total weight of the copolymer. Alternatively, the fluoropolymer can be pre-blended in some manner with a rigid copolymer, such as an aromatic polycarbonate resin or SAN to form an agglomerated material for use as an anti-drip agent. Either method can be used to produce an encapsulated fluoropolymer.

The anti-dripping agent is used in an amount from 0.1 to 5 wt. %, specifically 0.5 to 3 wt. %, more specifically 0.5 to 1.5 wt. %, based on the total weight of the composition.

The reinforcing filler can be particulate or fibrous. A combination of different types of reinforcing fillers can be used, for example a combination of a particulate reinforcing filler and a fibrous reinforcing filler.

Particulate reinforcing fillers agents include, for example, silicates and silica powders such as aluminum silicate (mullite), synthetic calcium silicate, zirconium silicate, fused silica, crystalline silica graphite, natural silica sand, or the like; boron powders such as boron-nitride powder, boron-silicate powders, or the like; oxides such as TiO₂, aluminum oxide, magnesium oxide, or the like; calcium sulfate (as its anhydride, dihydrate or trihydrate); calcium carbonates such as chalk, limestone, marble, synthetic precipitated calcium carbonates, or the like; talc, including fibrous, modular, needle shaped, lamellar talc, or the like; wollastonite; surface-treated wollastonite; glass spheres such as hollow and solid glass spheres, silicate spheres, cenospheres, aluminosilicate (armospheres), or the like; kaolin, including hard kaolin, soft kaolin, calcined kaolin, kaolin comprising various coatings known in the art to facilitate compatibility with the polymeric matrix resin, or the like; as well as additional fillers and reinforcing agents such as mica, clay, feldspar, flue dust, fillite, quartz, quartzite, perlite, tripoli, diatomaceous earth, carbon black, or the like, or combinations comprising at least one of the foregoing fillers or reinforcing agents. Specific particulate reinforcing fillers include talc and mica.

Suitable fibrous reinforcing fillers include fibers comprising glass, ceramic, or carbon, specifically glass that is relatively soda free, more specifically fibrous glass filaments comprising lime-alumino-borosilicate glass, which are also known as “E” glass. The fibers can have diameters of 6 to 30 micrometers. The fibrous fillers may be provided in the form of monofilament or multifilament fibers and may be used either alone or in combination with other types of fiber, through, for example, co-weaving or core/sheath, side-by-side, orange-type or matrix and fibril constructions, or by other methods known to one skilled in the art of fiber manufacture. Suitable cowoven structures include, for example, glass fiber-carbon fiber, carbon fiber-aromatic polyimide (aramid) fiber, and aromatic polyimide fiberglass fiber or the like. Fibrous fillers may be supplied in the form of, for example, rovings, woven fibrous reinforcements, such as 0-90 degree fabrics or the like; non-woven fibrous reinforcements such as continuous strand mat, chopped strand mat, tissues, papers and felts or the like; or three-dimensional reinforcements such as braids.

The fillers can be treated with a variety of coupling agents to improve adhesion to the polymer matrix, for example with amino-, epoxy-, amido- or mercapto-functionalized silanes, as well as with organometallic coupling agents, for example, titanium or zirconium based compounds.

The reinforcing fillers are present in an amount from 10 to 50 wt. %, specifically from 10 to 30 wt. %, based on the total weight of the composition.

The compositions may, optionally, further comprise other conventional additives used in polyester compositions such as non-reinforcing fillers, stabilizers such as antioxidants, thermal stabilizers, radiation stabilizers, and ultraviolet light absorbing additives, mold release agents, plasticizers, quenchers, lubricants, antistatic agents and processing aids. Other ingredients, such as dyes, pigments, laser marking additives, and the like can be added for their conventional purposes. An impact modifier can be present. A combination comprising one or more of the foregoing or other additives can be used. Each of the foregoing additives, except for the non-reinforcing filler and impact modifier, when present, is used in amounts typical for polyester compositions, for example 0.001 to 5 wt. % of the total weight of the composition, specifically 0.01 to 2 wt. % of the total weight of the composition.

When used, the impact modifier is a functional impact modifier, e.g., a polymeric or non-polymeric compound that reacts with the polyester and that increases the impact resistance of the composition. The reactive part of the impact modifier can be monofunctional or polyfunctional, and includes but is not limited to functional groups such as carboxylic acids, carboxylic acid anhydrides, amines, epoxides, carbodiimides, orthoesters, oxazolines, oxiranes, and aziridines. One example of a functional impact modifier is an epoxy functional core-shell polymer with a core prepared from butyl acrylate monomer, available commercially from Rohm and Haas as EXL 2314.

A sub category of these functional impact modifiers includes carboxy reactive impact modifiers. An example of a carboxy reactive compound having impact modifying properties is a co- or terpolymer including units of ethylene and glycidyl methacrylate (GMA), sold by Arkema. A typical composition of such a glycidyl ester impact modifier is about 67 wt. % ethylene, 25 wt. % methyl methacrylate and 8 wt. % glycidyl methacrylate impact modifier, available from Arkema under the brand name LOTADER AX8900. Another example of a carboxy reactive compound that has impact modifying properties is a terpolymer made of ethylene, butyl acrylate and glycidyl methacrylate (e.g., the ELVALOY PT or PTW series from Dupont).

Examples of carboxy-reactive groups include and are not limited to epoxides, carbodiimides, orthoesters, oxazolines, oxiranes, aziridines, and anhydrides. The carboxy-reactive material can also include other functionalities that are either reactive or non-reactive under the described processing conditions. Non-limiting examples of reactive moieties include reactive silicon-containing materials, for example epoxy-modified silicone and silane monomers and polymers. If desired, a catalyst or co-catalyst system can be used to accelerate the reaction between the carboxy-reactive material and the polyester.

The term “polyfunctional” or “multifunctional” in connection with the carboxy-reactive material means that at least two carboxy-reactive groups are present in each molecule of the material. Particularly useful polyfunctional carboxy-reactive materials include materials with at least two reactive epoxy groups. The polyfunctional epoxy material can contain aromatic and/or aliphatic residues. Examples include epoxy novolac resins, epoxidized vegetable (e.g., soybean, linseed) oils, tetraphenylethylene epoxide, styrene-acrylic copolymers containing pendant glycidyl groups, glycidyl methacrylate-containing polymers and copolymers, and difunctional epoxy compounds such as 3,4-epoxycyclohexylmethyl-3,4-epoxycyclohexanecarboxylate.

Suitable styrenic monomers include, but are not limited to, styrene, alpha-methyl styrene, vinyl toluene, p-methyl styrene, t-butyl styrene, o-chlorostyrene, and mixtures comprising at least one of the foregoing. In certain embodiments, the styrenic monomer is styrene and/or alpha-methyl styrene.

The difunctional epoxide compounds can be made by techniques well known to those skilled in the art. For example, the corresponding α- or β-dihydroxy compounds can be dehydrated to produce the epoxide groups, or the corresponding unsaturated compounds can be epoxidized by treatment with a peracid, such as peracetic acid, in well-known techniques. The compounds are also commercially available.

Other preferred materials with multiple epoxy groups are acrylic and/or polyolefin copolymers and oligomers containing glycidyl groups incorporated as side chains. Suitable epoxy-functional materials are available from Dow Chemical Company under the trade name D.E.R.332, D.E.R.661, and D.E.R.667; from Resolution Performance Products under the trade name EPON Resin 1001F, 1004F, 1005F, 1007F, and 1009F; from Shell Oil Corporation under the trade names EPON 826, 828, and 871; from Ciba Specialty Chemicals under the trade names CY-182 and CY-183; and from Dow Chemical Co. under the tradename ERL-4221 and ERL-4299.

The non-functionalized part of the functional impact modifier could be derived from a variety of sources. This includes but are not limited to substantially amorphous copolymer resins, including but not limited to acrylic rubbers, ASA rubbers, diene rubbers, organosiloxane rubbers, EPDM rubbers, SBS or SEBS rubbers, ABS rubbers, MBS rubbers and glycidyl ester impact modifiers.

The acrylic rubber is a preferably core-shell polymer built up from a rubber-like core on which one or more shells have been grafted. Typical core material consists substantially of an acrylate rubber. Preferable the core is an acrylate rubber of derived from a C4 to C12 acrylate. Typically, one or more shells are grafted on the core. Usually these shells are built up for the greater part from a vinyl aromatic compound and/or a vinyl cyanide and/or an alkyl(meth)acrylate and/or (meth)acrylic acid. Preferable the shell is derived from an alkyl(meth)acrylate, more preferable a methyl(meth)acrylate. The core and/or the shell(s) often comprise multi-functional compounds that may act as a cross-linking agent and/or as a grafting agent. These polymers are usually prepared in several stages. The preparation of core-shell polymers and their use as impact modifiers are described in U.S. Pat. Nos. 3,864,428 and 4,264,487. Especially preferred grafted polymers are the core-shell polymers available from Rohm & Haas under the trade name PARALOID®, including, for example, PARALOID® EXL3691 and PARALOID® EXL3330, EXL3300 and EXL2300. Core shell acrylic rubbers can be of various particle sizes. The preferred range is from 300-800 nm, however larger particles, or mixtures of small and large particles, may also be used. In some instances, especially where good appearance is required acrylic rubber with a particle size of 350-450 nm may be preferred. In other applications where higher impact is desired acrylic rubber particle sizes of 450-550 nm or 650-750 nm may be employed.

Acrylic impact modifiers contribute to heat stability and UV resistance as well as impact strength of polymer compositions. Other preferred rubbers useful herein as impact modifiers include graft and/or core shell structures having a rubbery component with a Tg (glass transition temperature) below 0° C., preferably between about −40° to about −80° C., which comprise poly-alkylacrylates or polyolefins grafted with poly(methyl)methacrylate or styrene-acrylonitrile copolymer. Preferably the rubber content is at least about 10% by weight, most preferably, at least about 50%.

Typical other rubbers for use as non-functionalized part of the functional impact modifier herein are the butadiene core-shell polymers of the type available from Rohm & Haas under the trade name PARALOID® EXL2600. Most preferably, the impact modifier will comprise a two-stage polymer having a butadiene based rubbery core, and a second stage polymerized from methyl methacrylate alone or in combination with styrene. Impact modifiers of the type also include those that comprise acrylonitrile and styrene grafted onto cross-linked butadiene polymer, which are disclosed in U.S. Pat. No. 4,292,233 herein incorporated by reference.

Other suitable impact modifiers may be mixtures comprising core shell impact modifiers made via emulsion polymerization using alkyl acrylate, styrene, and butadiene. These include, for example, methyl methacrylate-butadiene-styrene (MBS) and methyl methacrylate-butyl acrylate core shell rubbers.

In one embodiment, the composition can further include mold-release agents. Examples of the mold-release agents include, but are not limited to natural and synthetic paraffins, polyethylene waxes, fluorocarbons, and other hydrocarbon mold-release agents; stearic acid, hydroxystearic acid, and other higher fatty acids, hydroxyfatty acids, and other fatty acid mold-release agents; stearic acid amide, ethylene bisstearamide, and other fatty acid amides, alkylenebisfatty acid amides, and other fatty acid amide mold-release agents; stearyl alcohol, cetyl alcohol, and other aliphatic alcohols, polyhydric alcohols, polyglycols, polyglycerols and other alcoholic mold release agents; butyl stearate, pentaerythritol tetrastearate, and other lower alcohol esters of fatty acid, polyhydric alcohol esters of fatty acid, polyglycol esters of fatty acid, and other fatty acid ester mold release agents; silicone oil and other silicone mold release agents, and mixtures of any of the aforementioned. The amount of the mold release agent is generally at least 0.1 wt. %, specifically from 0.1 to 2 wt. %, more specifically from 0.5 to 1 wt. %, based on the total weight of the composition.

A composition of the invention may further contain a heat stabilizer. Exemplary heat stabilizers include hindered phenol stabilizers, organic thioether stabilizers, organic phosphite stabilizers, hindered amine stabilizers, epoxy stabilizers, and mixtures thereof. The heat-resistant stabilizer may be added in the form of a solid or liquid. The amount of the heat stabilizer that can be in the composition is generally at least 0.01 wt. %, specifically from 0.01 to 3 wt. %, more specifically from 0.05 to 1 wt. %, or from 05 to 0.5 wt. %, based on the total weight of the composition.

The compositions are generally made by combining suitable amounts of components by melt blending, for example in an extruder. The components may be compounded simultaneously, separately, or in combinations containing two or three of the components. Various of the components can be added in the form of a masterbatch. The extrusion process can include one or more passes through an extruder.

The compositions can be formed, shaped or molded into articles using common thermoplastic processes such as film and sheet extrusion, molding, and the like. Preferably, the ingredients are pre-compounded, pelletized, and then molded. Pre-compounding can be carried out in conventional equipment. For example, after pre-drying the polyester composition (e.g., for four hours at 120° C.), a single screw extruder may be fed with a dry blend of the ingredients, the screw employed having a long transition section to ensure proper melting. Alternatively, a twin screw extruder with intermeshing co-rotating screws can be fed with resin and additives at the feed port and reinforcing additives (and other additives) may be fed downstream. In either case, a generally suitable melt temperature will be 230° C. to 300° C. The pre-compounded composition can be extruded and cut up into molding compounds such as conventional granules, pellets, and the like by standard techniques. The composition can then be molded in any equipment conventionally used for thermoplastic compositions, such as a Newbury type injection molding machine with conventional cylinder temperatures, at 230° C. to 280° C., and conventional mold temperatures at 55° C. to 95° C.

Different molding techniques can be used, for example injection molding, gas-assist injection molding, extrusion molding, compression molding, blow molding, and the like. Injection molding is a process wherein an amount of polymer several times that necessary to produce an article is heated in a heating chamber to a viscous liquid and then injected under pressure into a mold cavity. The polymer remains in the mold cavity under high pressure until it is cooled and is then removed. The term “injection molding” also encompasses the relatively new advance of reaction injection molding, wherein a two-part semi-liquid resin blend is made to flow through a nozzle and into a mold cavity where it polymerizes as a result of a chemical reaction. Injection molding and injection molding apparatii are discussed in further detail in U.S. Pat. No. 3,915,608 to Hujick; U.S. Pat. No. 3,302,243 to Ludwig; and U.S. Pat. No. 3,224,043 to Lameris. Injection molding is the fastest of the thermoplastic processes, and thus is generally used for large volume applications such as automotive and consumer goods. The cycle times range between 20 and 60 seconds. Injection molding also produces highly repeatable near-net shaped parts. The ability to mold around inserts, holes, and core material is another advantage. Finally, injection molding generally offer the best surface finish of any process. The skilled artisan will know whether injection molding is the best particular processing method to produce a given article according to the present invention. In one embodiment, pellets of the composition are dried in an oven over a suitable period, e.g., 12 hours at 120° C., molded in injection molding machine with a suitable melt temperature profile, e.g., 100-240-250-260-260° C., where the temperature of the mold is kept suitably for processing, e.g., at 60° C.

Examples of suitable articles include and are not limited to relay housing controls, timer housing structures, connectors, controls, and switches. In one embodiment, for instance, a suitable article may include an electric connector which includes a connector shell and a conductor rack, the conductor rack including a—shaped rack body having a top wall, a bottom wall, and a side wall connected between a rear end of the top wall and a rear end of the bottom wall at one end, the bottom wall having a plurality of wire holes at a front end thereof, and a plurality of conductors respectively inserted through the wire holes on the bottom wall and extended out of the rack body.

The physical properties of the compositions and the articles made (e.g., articles molded or extruded from the compositions) from the compositions generally exhibit highly useful combination of GWIT, CTI, and flame retarding properties. Generally, the components and amounts of each component are selected so as to impart (i) a GWIT that is at least 775° C. and (ii) a CTI that is at least 250 V to the composition or to an article molded or extruded from the composition.

In one embodiment, a composition comprising a poly(ethylene terephthalate) having an intrinsic viscosity from 0.5 to 0.9 dl/g, melamine GWIT of at least 775° C. When a polyamide is present in the composition, a 1-millimeter thick sample comprising the composition has a GWIT temperature of at least 775° C. Further when a polyamide is present in the composition, a 1-millimeter thick sample comprising the composition has a CTI that is at least 400 V.

Particularly suitable compositions (and articles molded or extruded from the compositions) also exhibit a flame retardance rating of V0, as per UL 94, measured on a 0.8 mm thick sample.

The invention is further described in the following illustrative examples in which all parts and percentages are by weight unless otherwise indicated.

### EXAMPLES

### Standards/Procedures

Glow Wire Ignition Temperature (GWIT), measured in accordance with IEC 695-2-1/3, is expressed as the temperature (in ° C.), which is 25° C. hotter than the maximum temperature of the tip of the glow-wire which does not cause ignition of the material during three sequential tests.

Comparative Tracking Index (CTI) is expressed as that voltage which causes tracking after 50 drops of 0.1 percent ammonium chloride solution have fallen on the material. The results of testing the nominal 3 mm thickness were considered representative of the material's performance in any thickness. Since the target CTI requirement was 250 Volts, if a composition passed the 250 volts requirement by the method described as above, it was considered to have passed the CTI test. If it is not passing the test, it is deemed to have failed. Wherever possible, the test has been conducted at 400 volts and 600 volts as well. Similar pass/fail criterion was employed for those voltages as well.

Flame retardancy tests were performed following the procedure of Underwriter's Laboratory Bulletin 94 entitled “Tests for Flammability of Plastic Materials, UL94.” According to this procedure, materials may be classified as HB, V0, V1, V2, VA, and/or VB on the basis of the test results obtained for five samples. To achieve a rating of V0, in a sample placed so that its long axis is 180 degrees to the flame, the average period of flaming and/or smoldering after removing the igniting flame does not exceed five seconds and none of the vertically placed samples produces drips of burning particles that ignite absorbent cotton. Five bar flame out time (FOT) is the sum of the flame out time for five bars, each lit twice for a maximum flame out time of 50 seconds. To achieve a rating of V1, in a sample placed so that its long axis is 180 degrees to the flame, the average period of flaming and/or smoldering after removing the igniting flame does not exceed twenty-five seconds and none of the vertically placed samples produces drips of burning particles that ignite absorbent cotton. Five bar flame out time is the sum of the flame out time for five bars, each lit twice for a maximum flame out time of 250 seconds. Compositions of this invention are expected to achieve a UL94 rating of V1 and/or V0 at a thickness of lower than 1.5 mm and typically at 0.8 mm.

### Materials

The materials used in the following examples are shown in Table A.

TABLE A

| Component | Description | Source |
|---|---|---|
| PET | Poly(ethylene terephthalate) CAS 25038-59-9 | EASTMAN |
| PA 6.6 | Polymer of hexamethylene diamine & adipic acid | RHODIA |
| | (CAS 32131-17-2) | |
| LOTADER | Ethylene-methyl acrylate-glycidyl methacrylate | ARKEMA |
| | copolymer (CAS 35830-43-4) | |
| MPP | Melamine Polyphosphate (CAS 56386-64-2) | CIBA SC |
| BR-PS | Brominated Polystyrene (CAS 88497-56-7) | ALBEMARLE |
| ADR | Styrene-acrylate-epoxy oligomer (CAS | JOHNSON |
| | Proprietary) | |
| ECN | Epoxy cresol novolac resin in ethylene-ethyl | GE PLASTICS |
| | acrylate (CAS 29690-82-2) | |
| KSS | Potassium diphenylsulphon-3-sulphonate (CAS | ARICHEM |
| | 63316-43-8) | |
| ATO | Antimony trioxide, masterbatch in PBT (CAS | CAMPINE |
| | 1309-64-4) | |
| GLASS | SiO₂ - fibrous glass (CAS 65997-17-3) | NEG |
| TSAN | Polytetrafluoroethylene/styrene-acrylonitrile | GE PLASTICS |
| | (CAS 9002-84-0) | |
| AO1010 | Pentaerythritol-tetrakis(3-(3,5-di-tert-butyl-4- | GREAT LAKES |
| | hydroxy-phenyl)propionate)(CAS 6683-19-8) | |
| PBT | Poly(butylene terephthalate) (CAS 30965-26-5) | SABIC |
| TALCUM | Talcum (3MgO—4SiO₂—H₂O) (CAS 14807-96-6) | FINNMINERALS |
| SAPP | Sodium hydrogen pyrophosphate (CAS 7758-16- | SMIDT |
| | 9) | |
| PETS | Pentaerythritol tetrastearate (CAS 115-83-3) | FACI |
| ANTIM | Sodium antimonate, masterbatch in PET (CAS | RAVAGO |
| | 15432-85-6) | |
| AO1098 | N,N-Hexane-1,6-diylbis[3-(3,5-di-tert-butyl-4- | CIBA SC |
| | hydroxyphenylpropionamide)] (CAS 23128-74- | |
| | 7) | |
| PEPQ | Mixture of tetrakis(2,4-di-tert-butylphenyl-4,4- | CIBA SC |
| | biphenylene diphosphonite (CAS 38613-77-3) | |
| | (main component) and PEPQ (CAS 119345-01- | |
| | 6) | |
| ULTRATALC | Talcum, masterbatch in PET (CAS 14807-96-6) | RAVAGO |
| MEC | Melamine cyanurate (CAS 37640-57-6) | CIBA SC |
| BR-ACR | Poly (pentabromobenzylacrylate) (CAS 59447- | EUROBROOM |
| | 57-3) | |
| EEA | Ethylene-ethyl acrylate copolymer (CAS 9010- | ASHLAND |
| | 86-0) | |

### Preparation of Compositions: General Method

In addition to the components shown in Tables 1-3, the compositions contained a stabilizer additive package (STAB/ADD) selected from the following components (amounts based on the weight of the total composition): EEA (5.0%); SAPP (5.0%); AO1010 (0.1%); ADR (0.2%); KSS (0.2%); PETS (0.2%); ECN (0.5%); AO1098 (0.1%); PEPQ (0.1%); and ULTRATALC (2 to 8%).

The components of the examples shown in Tables 1-3 were extruded on a 25 mm Werner Pfleiderer Twin Screw Extruder with a vacuum vented mixing screw, at a barrel and die head temperature between 250 and 275° C. and 150 to 300 rpm screw speed. The extruder has 3 independent feeders for different raws and can be operated at a maximum rate of 50 kg/hr. The extrudate was cooled through a water bath prior to pelletizing. Test parts were injection molded on an ENGEL molding machine with a set temperature of approximately 265 to 275° C. The pellets were dried for 4-6 hours at 120° C. In a forced air-circulating oven prior to injection molding.

### Examples 1-8

The compositions of Examples 1-8 illustrate the effect of varying the components of the compositions, in particular the effect of using PBT, and use of an impact modifier. Compositions in accordance with the invention have a CTI of 2 or less, and a 1-millimeter and a 3-millimeter sample have a GWIT temperature of at least 775° C.

TABLE 1

| Component | 1* | 2 | 3* | 4* | 5* | 6 | 7 | 8* |
|---|---|---|---|---|---|---|---|---|
| PET IV 0.8 | — | 36 | — | — | — | 29 | 29 | 44 |
| PBT | 43 | — | 44 | 29 | 29 | — | — | — |
| PA 6.6 | — | 5 | — | 15 | 15 | 15 | 15 | — |
| MPP | — | 5 | 5 | — | 5 | 5 | — | 5 |
| MEC | — | — | — | 5 | — | — | 5 | — |
| BR-PS | — | 10 | 10 | 10 | 10 | 10 | 10 | 10 |
| BR-ACR | 7 | — | — | — | — | — | — | — |
| ATO | 4 | — | 5 | 5 | 5 | 5 | 5 | 5 |
| ANTIM | — | 7 | — | — | — | — | — | — |
| TSAN | 0.6 | 0.6 | 0.1 | 0.1 | 0.1 | 0.1 | 0.1 | 0.1 |
| LOTADER | — | 1 | — | — | — | — | — | — |
| Glass | 15 | 15 | 15 | 15 | 15 | 15 | 15 | 15 |
| Talcum | 20 | 20 | 20 | 20 | 20 | 20 | 20 | 20 |
| Property | — | — | — | — | — | — | — | — |
| STAB/ADD | 10.0 | 0.5 | 0.8 | 0.8 | 0.8 | 1.0 | 1.0 | 1.0 |
| GWIT, | Fail | Pass | Fail | Fail | Fail | Pass | Pass | Fail |
| 775° C., 1 mm | | | | | | | | |
| GWIT, | Pass | Pass | Fail | Pass | Pass | Pass | Pass | Pass |
| 775° C., 3 mm | | | | | | | | |
| CTI** | 0 | ≦1 | ≦2 | ≦2 | ≦2 | ≦2 | ≦2 | ≦2 |
| | (Pass) | (Pass) | (Pass) | (Pass) | (Pass) | (Pass) | (Pass) | (Pass) |
| UL 94 V0 | 0.8 mm | 0.8 mm | 0.8 mm | 0.8 mm | 0.8 mm | 0.8 mm | 0.8 mm | 0.8 mm |

*Comparative Example
**A CTI reading of 2 or less was considered a “Pass” and a CTI reading more than 2 was considered a “Fail”

As can be seen from the data in Table 1, compositions containing a combination of low viscosity PET, polyamide, melamine polyphosphate or melamine cyanurate, a halogenated flame retardant, and an inorganic flame retardant synergist (Exs. 2, 6, and 7) pass both of the GWITs and CTI. Substitution of PBT for the PET (Ex. 5) results in failure of the GWIT at 1.0 mm. Elimination of polyamide (Ex. 8) results in failure of the GWIT at 1.0 mm.

### Examples 9-15

The compositions of Examples 9-15 illustrate the effect of varying the components of the compositions, in particular the effect of omitting MPP, use of a higher viscosity PET, and use of polyamide.

TABLE 2

| | 9 | 10 | 11* | 12 | 13 | 14* | 15* |
|---|---|---|---|---|---|---|---|
| PET IV 0.8 | 36 | 29 | 44 | — | 27 | 42 | 32 |
| PET IV 0.5 | — | — | — | 27 | — | — | — |
| PA 6.6 | 5 | 15 | — | — | — | — | 15 |
| PA 6.6 Low | — | — | — | — | 15 | — | — |
| IV | | | | | | | |
| PA 6.6 Dry | — | — | — | 15 | — | — | — |
| LV | | | | | | | |
| MPP | 5 | 5 | 5 | 5 | 5 | 5 | — |
| BR-PS | 10 | 10 | 10 | 10 | 10 | 10 | 10 |
| BR-ACR | — | — | — | — | — | — | — |
| ATO | — | 5 | 5 | — | — | — | — |
| ANTIM | 7 | — | 7 | 7 | 7 | 7 | 7 |
| TSAN | 0.6 | 0.1 | 0.1 | 0.6 | 0.6 | 0.6 | 0.6 |
| LOTADER | 1 | — | — | — | — | — | — |
| Glass | 15 | 15 | 15 | 15 | 15 | 15 | 15 |
| Talcum | 20 | 20 | 20 | 20 | 20 | 20 | 20 |
| STAB/ADD | 0.5 | 1.0 | 1.0 | 0.6 | 0.6 | 0.6 | 0.6 |
| GWIT, 775° C., 1 mm | Pass | Pass | Fail | Pass | Pass | Fail | Fail |
| GWIT, 775° C., 3 mm | Pass | Pass | Pass | Pass | Pass | Pass | Fail |
| CTI | ≦1 | ≦2 | ≦2 | ≦1 | ≦1 | ≦2 | ≦1 |
| | (Pass) | (Pass) | (Pass) | (Pass) | (Pass) | (Pass) | (Pass) |
| UL 94 V0 | 0.8 mm | 0.8 mm | 0.8 mm | 0.8 mm | 0.8 mm | 0.8 mm | 0.8 mm |

*Comparative Example
**A CTI reading of 2 or less was considered a “Pass” and a CTI reading more than 2 was considered a “Fail”.

As can be seen from the data in Table 2, use of a higher viscosity PET results in a CTI rating of 1 (Ex. 9). Omission of MPP (Ex. 15) results in failure of GWIT and a CTI rating of one. Omission of PA (Exs. 11 and 14) result in failure of GWIT at 1 mm.

### Examples 16-24

The compositions of Examples 16-24 illustrate the effect of varying the components of the compositions. Polycarbonate was used in Examples 20-24.

TABLE 3

| Component | 16* | 17 | 18 | 19* | 20* | 21 | 22 | 23 | 24* |
|---|---|---|---|---|---|---|---|---|---|
| PET IV 0.8 | — | 27 | 38 | 45 | 14 | 17 | 14 | 15 | 20 |
| PBT | 55 | — | — | — | — | — | — | — | — |
| PA 6.6 | — | 15 | 5 | — | 10 | 10 | 10 | 10 | — |
| PC | — | — | — | — | 15 | 17 | 15 | 17 | 22 |
| MPP | — | 5 | 5 | — | — | 5 | 10 | 5 | 5 |
| BR-PS | — | 12 | 11 | 10 | 11 | 11 | 11 | 11 | 11 |
| BR-ACR | 10 | — | — | — | — | — | — | — | — |
| ATO | 4 | 5 | — | — | 5 | 5 | 5 | 5 | 5 |
| ANTIM | — | — | 7 | 7 | — | — | — | — | — |
| TSAN | 0.5 | 0.4 | 0.6 | 0.4 | 0.2 | 0.2 | 0.2 | 0.2 | 0.2 |
| LOTADER | — | 5 | 1 | — | 2 | 2 | 2 | 2 | 2 |
| Glass | 30 | 30 | 30 | 30 | 30 | 30 | 30 | 30 | 30 |
| STAB/ADD | 0.1 | 0.5 | 2.5 | 7.8 | 13.1 | 3.1 | 3.1 | 5.6 | 5.6 |
| GWIT, 775° C., 1 mm | Fail | Pass | Pass | Pass | Fail | Pass | Pass | Pass | Pass |
| GWIT, 775° C., 3 mm | Fail | Pass | Pass | Pass | Pass | Pass | Pass | Pass | Pass |
| CTI** | 2 | 0 | 1-2 | 3 | ≦2 | ≦2 | ≦2 | ≦2 | 3 |
| | (Pass) | (Pass) | (Pass) | (Fail) | (Pass) | (Pass) | (Pass) | (Pass) | (Fail) |
| UL 94 V0 | 0.8 mm | 0.8 mm | 0.8 mm | 0.8 mm | 0.8 mm | 0.8 mm | 0.8 mm | 0.8 mm | 0.8 mm |

*Comparative Example
**A CTI reading of 2 or less was considered a “Pass” and a CTI reading more than 2 was considered a “Fail”

As can be seen from the data in Table 3, elimination of both PA and MPP (Ex. 9) results in failure for GWIT at both 1 mm and 3 mm. Elimination of the polyamide (Exs. 19 and 20) results failure in CTI. As evidenced by Example 20, the elimination of MPP results in the failure of GWIT at 1 mm.

Although the present invention has been described in detail with reference to certain preferred versions thereof, other variations are possible. Therefore, the spirit and scope of the appended claims should not be limited to the description of the versions contained therein.

1. A composition comprising, based on the total weight of the composition:
from 5 to 60 wt. % of a poly(ethylene terephthalate) having an intrinsic viscosity from 0.5 to 0.9 dl/g;
from more than 0 to 25 wt % of a polyamide;
from 0.5 to 10 wt. % of melamine component;
from 5 to 20 wt. % of a halogenated organic flame retarding synergist;
from 2 to 10 wt % of an inorganic flame retarding synergist;
from 0.1 to 5 wt. % of an anti-dripping agent; and
from 10 to 50 wt. % of a reinforcing filler;
wherein a 0.8 millimeter thick sample comprising the composition meets the UL 94 standard of V0, a sample comprising the composition has a Comparative Tracking Index of at least 250 Volts, and a 3 millimeter thick sample comprising the composition has a Glow Wire Ignition Temperature of at least 775° C.

2. The composition of claim 1, wherein the melamine component is polyphosphate or melamine cyanurate; and
wherein a 1-millimeter thick sample comprising the composition has a Glow Wire Ignition Temperature of at least 775° C.

3. The composition of claim 2, wherein a sample comprising the composition has a Comparative Tracking Index of at least 400 Volts.

4. (canceled)

5. (canceled)

6. The composition of claim 2, wherein the composition further comprises polycarbonate in an amount ranging from more than 0 to less than 22 wt %, based on the total weight of the composition.

7. The composition of claim 6, wherein the polycarbonate comprises at least 60% units derived from bisphenol A.

8. The composition of claim 2, wherein the composition further comprises a polyester that is different from the poly(ethylene terephthalate).

9. The composition of claim 2, wherein the different polyester is selected from the group consisting of poly(1,4-butylene terephthalate), poly(butylene naphthanoate), poly(cyclohexane dimethylene terephthalate), poly(cyclohexylenedimethylene ethylene terephthalate), poly(propylene terephthalate), and a combination thereof.

10. The composition of claim 2, wherein the composition does not further comprise a polyester that is different from the poly(ethylene terephthalate).

11. The composition of claim 2, wherein the polyamide is selected from the group consisting of Nylon-6, Nylon-6,6, Nylon-4,6, Nylon-12, Nylon-6,10, Nylon-6,9, Nylon-6/6T, Nylon-6,6/6T, polycaproamide, polyhexamethylene adipamide, polyhexaethylene sebacamide, polyundecamethylene adipamide, polyundecanamide, polydodecanamide, copolymerized polyamides of the foregoing, and a combination thereof.

12. The composition of claim 2, containing melamine polyphosphate and no melamine cyanurate.

13. The composition of claim 2, wherein the halogenated organic flame retarding agent is selected from the group consisting of ethane-1,2-bis (pentabromophenyl), brominated polystyrene, poly(pentabromobenzyl acrylate), 1,2-bis-(tetrabromophthalimido) ethane, phenol-capped carbonate pentamers of tetrabromobisphenol A carbonate oligomers, 2,4,6-tribromophenol-capped tetrabromobisphenol A carbonate oligomers, brominated polycarbonates, tetrabromobisphenol A diglycidyl ethers, and a combination thereof.

14. The composition of claim 2, wherein the inorganic flame retarding synergist comprises antimony.

15. The composition of claim 14, wherein the inorganic flame retarding synergist is selected from the group of antimony trioxide, antimony pentoxide, sodium antimonite, and a combination thereof.

16. The composition of claim 2, wherein the anti-dripping agent is a polymer-encapsulated poly(tetrafluoroethylene).

17. The composition of claim 2, wherein the reinforcing filler is selected from the group consisting of a particulate filler, a glass fiber, and a combination thereof.

18. The composition of claim 2, wherein the reinforcing filler is a combination of glass fibers and talc.

19. The composition of claim 2, further comprising an additive selected from the group consisting of antioxidants, lubricants, a thermal stabilizers, ultraviolet light absorbing additives, quenchers, plasticizers, mold release agents, antistatic agents, dyes, pigments, laser marking additives, radiation stabilizers, and a combination thereof.

20. The composition of claim 2, wherein the composition further comprises an impact modifier.

21. A method for the manufacture of a composition, comprising blending the components of the composition of claim 2.

22. An article comprising the composition of claim 2.

23. The article of claim 22, wherein the article is an injection molded article.

24. The article of claim 22, wherein the article is a relay housing control, a timer housing structure, a connector, a control, a switch, and a combination thereof.

25. A method of forming an article, comprising shaping, extruding, calendaring, or molding the composition of claim 2 to form the article.

26. A composition comprising, based on the total weight of the composition:
from 5 to 50 wt. % of a poly(ethylene terephthalate) having an intrinsic viscosity from 0.5 to 0.9 dl/g;
from 5 to 20 wt. % of a polyamide;
from 2.5 to 7.5 wt. % of melamine polyphosphate;
from 2.5 to 7.5 wt. % of an inorganic flame retarding synergist;
from 10 to 15 wt. % of a halogenated organic flame retarding synergist;
from 0.1 to 0.8 wt. % of an anti-dripping agent; and
from 25 to 35 wt. % of a reinforcing filler;
wherein a 3 millimeter thick sample comprising the composition has a Glow Wire Ignition Temperature of at least 775° C.;
a 0.8 millimeter thick sample comprising the composition meets the UL 94 standard of V0; and
wherein a sample comprising the composition has a Comparative Tracking Index of at least 250 Volts.

27. A composition comprising, based on the total weight of the composition:
from 10 to 50 wt. % of a poly(ethylene terephthalate) having an intrinsic viscosity from 0.5 to 0.9 dl/g;
from 5 to 20 wt. % of a polyamide;
from 2.5 to 7.5 wt. % of melamine polyphosphate;
from 2.5 to 7.5 wt. % of an inorganic flame retarding synergist;
from 10 to 15 wt. % of a halogenated organic flame retarding synergist;
from 0.1 to 0.8 wt. % of an anti-dripping agent; and
from 10 to 50 wt. % of a reinforcing filler;
wherein a 1 millimeter thick sample comprising the composition has a Glow Wire Ignition Temperature of at least 775° C.;
wherein a 0.8 millimeter thick sample comprising the composition meets the UL 94 standard of V0; and
wherein a sample comprising the composition has a Comparative Tracking Index of at least 400 Volts.
